(19) United States
(12) Patent Application Publication
(10) Pub. No.: US 2020/0076362 A1
(43) Pub. Date: Mar. 5, 2020

(54) LIGHT COLLECTION AND REDIRECTION TO A SOLAR PANEL

(71) Applicant: BIGZ TECH INC., Montreal (CA)

(72) Inventors: Eliot AHDOOT, Dollard-des-Ormeaux (CA); Simon AHDOOT, Toronto (CA); Benjamin AHDOOT AHDOOT, Dollard-Des Ormeaux (CA)

(21) Appl. No.: 16/674,301

(22) Filed: Nov. 5, 2019

Related U.S. Application Data
(63) Continuation-in-part of application No. 15/680,552, filed on Aug. 18, 2017.
(60) Provisional application No. 62/377,894, filed on Aug. 22, 2016.

(51) Int. Cl. H02S 40/22; H02S 20/22; F21S 11/00; F21V 8/00; G01J 1/42

(52) U.S. Cl. CPC H02S 40/22; H02S 20/22; G01J 1/4204; G02B 6/0008; F21S 11/002

(57) ABSTRACT

There is provided a unit for light conversion in a building. The unit comprises a solar panel comprising photovoltaic cells without any light-absorbing or light-reflecting coating such as to be raw. The photovoltaic cells can have a wavelength range of conversion optimized for natural sunlight. The unit further comprises an enclosure surrounding the solar panel and preventing the exposure of the solar panel from direct light from outside the enclosure, the enclosure comprising an input. There is provided a light guide comprising an optical fiber and adapted for optical connection to the light collector, the light guide being connectable to the enclosure via the input, the light guide having an output end located by the input of the enclosure and directed toward a surface of the photovoltaic cells for illumination thereof. A light collector is provided outside the building for collecting sunlight and guiding the sunlight into the light guide.

### CROSS-REFERENCE TO RELATED APPLICATIONS

This application is a Continuation-in-Part of U.S. Ser. No. 15/680,552, filed Aug. 18, 2017, which claims the benefit of U.S. provisional patent application 62/377,894, filed Aug. 22, 2016, the specifications of which are hereby incorporated herein by reference in their entirety.

### BACKGROUND

### (a) Field

The subject matter disclosed generally relates to light collection and conversion. More specifically, it relates to an enclosed solar panel system.

### (b) Related Prior Art

Sunlight is an abundant source of energy. The ability to harvest sunlight for conversion into another form of energy is useful many purposes.

The building industry is making attempts to embrace solar energy. Rooftops of buildings are evolving over time, as buildings get adapted for the installation of solar panels on top of them. These solar panels can be photovoltaic cells that convert sunlight into electric power, or solar thermal panels that collect heat from the radiation for heating water, for example.

Retrofitting existing buildings to meet such needs can be difficult. Changing the location and orientation of a building to modify its exposure to sunlight is impossible. Modifying architectural elements of the building to integrate solar panels may not be feasible or may be impractical from an architectural point of view.

Furthermore, the addition of solar panels on the rooftop requires the roof to have access for maintenance staff and available space for the solar panels, a requirement that is worsened by the fact solar panels are usually inclined (i.e., they require a greater surface area) and require space in-between for the circulation of maintenance staff. Moreover, the roof must be able to withstand the significant weight of the solar panels.

### SUMMARY

According to an embodiment, there is provided a unit for light conversion in a building, the unit comprising:
a solar panel comprising photovoltaic cells without any light-absorbing or light-reflecting coating such as to be raw, the photovoltaic cells having a wavelength range of conversion optimized for natural sunlight;
an enclosure surrounding the solar panel and preventing the exposure of the solar panel from direct light from outside the enclosure, the enclosure comprising an input; and
a light guide comprising an optical fiber and adapted for optical connection to the light collector, the light guide being connectable to the enclosure via the input, the light guide having an output end located by the input of the enclosure and directed toward a surface of the photovoltaic cells for illumination thereof; and
a light collector located outside the building for collecting natural sunlight and substantially guiding the natural sunlight into the light guide, the light collector comprising a concave portion for light collection, the concave portion being one of a dish and a reflector of a lamp.

According to another embodiment, there is provided unit for light conversion receiving light from a light collector, the unit comprising:
a solar panel comprising photovoltaic cells without any light-absorbing or light-reflecting coating such as to be raw;
an enclosure surrounding the solar panel and preventing the exposure of the solar panel from direct light from outside the enclosure, the enclosure comprising an input; and
a light guide adapted for optical connection to the light collector located outside the enclosure, the light guide being connectable to the enclosure via the input.

According to another embodiment, there is provided unit for light conversion, the unit comprising:
a solar panel comprising uncoated photovoltaic cells; and
an enclosure surrounding the solar panel and comprising an input for a light guide connectable to the enclosure via the input.

According to another aspect of the invention, there is provided a system comprising a unit for light conversion in a building, the unit comprising:
a solar panel comprising photovoltaic cells, the solar panel being free of any light-absorbing coating or light-reflecting coating covering the photovoltaic cells, thus having raw photovoltaic cells exposed, the photovoltaic cells having a wavelength range of conversion optimized for natural sunlight;
an enclosure surrounding the solar panel and preventing an exposure of the solar panel from direct light from outside the enclosure, the enclosure comprising an input; and
   the system further comprising:
a light collector located outside the building for collecting natural sunlight and substantially guiding the natural sunlight into the light guide, the light collector comprising:
a concave portion for receiving incoming light and comprising a reflective inner surface in the concave portion facing the incoming light for reflecting the incoming light toward a focal spot defined by a geometry of the concave portion;
a light capturing element, located at the focal spot, and having a lightbulb shape to substantially capture the incoming light directed toward the focal spot and to reflect the incoming light within the light capturing element toward an exit thereof; and
a light guide comprising an end provided at the exit of the light capturing element for guiding captured light outside of the light collecting, the light guide having two ends and comprising an optical fiber adapted for optical connection, one of the two ends provided at the exit of the light capturing element, another one of the two ends, namely an output end, connectable to the enclosure via the input, the light guide having the output end located by the input of the enclosure and directed directly toward a surface of the photovoltaic cells for illumination thereof.

According to an embodiment, the light capturing element is transparent, wherein a refraction index of the light capturing element is in a range ensuring substantial total inner reflection in order to reflect the incoming light within the light capturing element toward the exit of the light capturing element.

According to another aspect of the invention, there is provided a unit for light conversion receiving light from a light collector, the unit comprising:
a solar panel comprising photovoltaic cells, the solar panel being free of any light-absorbing coating, or light-reflecting coating such as to be raw;
an enclosure surrounding the solar panel and preventing an exposure of the solar panel from direct light from outside the enclosure, the enclosure comprising an input opposing the solar panel, wherein the unit is free of any reflector such that the input points directly toward the solar panel to which it is opposed; and
a light collecting device comprising:
a concave portion for receiving incoming light and comprising a reflective inner surface in the concave portion facing the incoming light for reflecting the incoming light toward a focal spot defined by a geometry of the concave portion; and
a light guide having a light-receiving end held at the focal spot and toward the concave portion to substantially capture the incoming light directed toward the focal spot, the light guide extending from the light-receiving end held at the focal spot in the light collector located outside the enclosure to the enclosure, the light guide being connectable to the enclosure via the input.

According to an embodiment, there is further provided a collimator installed between the solar panel and the input for the light guide for a more uniform light intensity on the solar panel.

According to an embodiment, the collimator comprises an adjustable lens arrangement which focuses more or less to reach a predetermined, optimizes uniform light intensity on the solar panel.

According to another aspect of the invention, there is provided a system for a building for performing light conversion in a building, the system comprising:
at least one unit located inside the building and comprising:
a solar panel comprising photovoltaic cells, the solar panel being free of any light-absorbing coating, or light-reflecting coating covering the photovoltaic cells, thus having raw photovoltaic cells exposed; and
an enclosure surrounding the solar panel and comprising an input; and
at least one light collector located outside the building, the at least one light collector comprising:
a concave portion for receiving incoming light and comprising a reflective inner surface in the concave portion facing the incoming light for reflecting the incoming light toward a focal spot defined by a geometry of the concave portion; and
a light guide forming a network and extending from the at least two light collectors to the at least one unit, the light guide having a light-receiving end held at the focal spot and toward the concave portion to substantially capture the incoming light directed toward the focal spot, the light guide being connectable to the enclosure of the at least one unit via the input.

According to an embodiment, the input for the light guide is installed at the focal spot to provide optical connection to the light collector.

According to an embodiment, the at least two unit comprises more than two units in the building, the light guide forming the network extending from the at least one light collector to the at least one unit.

According to an embodiment, each of the at least one light collector comprises a concave portion directly exposed to the outside.

According to an embodiment, there is further provided at least one lighting output to which the light guide is connectable to output light therefrom.

According to an embodiment, there is further provided a light sensor to monitor the light outputted from the lighting output, the light sensor instructing a level of electrical lighting in the room of the light output.

As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 is a picture illustrating a sunlight harnessing system, according to the prior art;

FIG. 2 is a side view of a system comprising a light collector feeding a solar panel in an enclosure, according to an embodiment;

FIG. 3 is a picture showing a perspective view of a light collector, according to an embodiment;

FIG. 4 is a cross-section of a light collector with incoming light rays being reflected to a focal point, according to an embodiment;

FIG. 5 is a side view of a light capturing element with incoming light rays being reflected therein and captured, according to an embodiment; and

FIG. 6 is a side view of a light collector with a light capturing element installed at a focal spot therein and a light guide extending therefrom, according to an embodiment;

FIG. 7 is a side view of a system comprising a plurality of light collectors feeding a plurality of enclosed solar panels installed side-by-side, according to an embodiment;

FIG. 8 is a side view of a system comprising a plurality of light collectors feeding a plurality of piled-up enclosed solar panels, according to an embodiment;

FIG. 9 is a side view of a system comprising a plurality of light collectors feeding a plurality of piled-up enclosed solar panels, according to another embodiment;

FIG. 10 is a side view of a system comprising a plurality of light collectors feeding a plurality of piled-up enclosed solar panels and a lighting device, according to an embodiment;

FIG. 11 is a side view of an enclosure comprising a solar panel with a lens system, according to an embodiment;

FIG. 12 is a side view of a system comprising rooftop light collectors feeding enclosed solar panels in a building, according to an embodiment;

FIG. 13A is a side view of another embodiment of a light collector to be used in the system, according to an embodiment;

FIG. 13B is a perspective view illustrating of a light collector comprising a dish according to another embodiment;

FIG. 14A is a perspective view illustrating the dish and the light capturing element of the light collector of FIGS. 13A-13B;

FIG. 14B is a perspective view illustrating the support of the light collector of FIGS. 13A-13B;

FIG. 14C is a perspective view illustrating the brackets for the dish of the light collector of FIGS. 13A-13B;

FIG. 14D is a top view illustrating the configuration brackets for the dish of the light collector of FIGS. 13A-13B; and

FIG. 15 is a graph illustrating an optimal parabola and a real parabola of an off-the-shelf dish, according to an embodiment.

It will be noted that throughout the appended drawings, like features are identified by like reference numerals.

### DETAILED DESCRIPTION

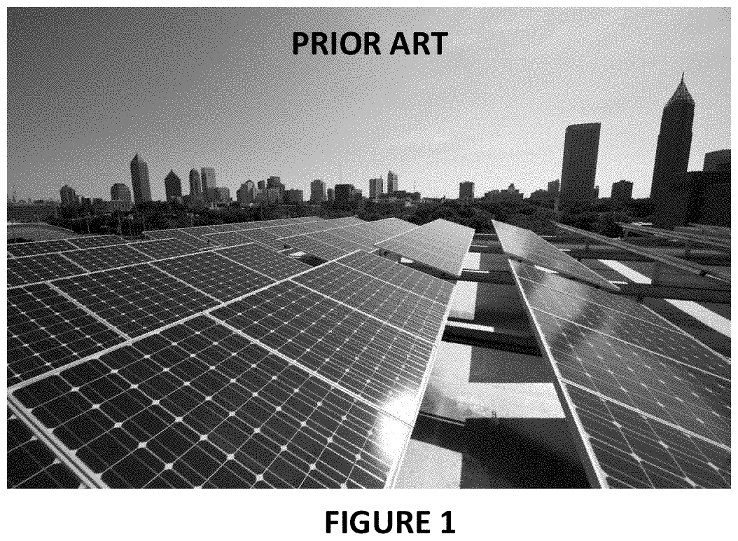

Referring to FIG. 1, there is shown a prior art system for harnessing solar energy. FIG. 1 is a picture of a real life system comprising solar panels on the rooftop of a building. On the picture, it is apparent that the real-life solar panels are bulky. The bulkiness is even worsened by the inclination of the solar panels, which is a common feature of solar panels installations in regions of middle to high latitude because it is preferable if solar panels are perpendicular to the incoming sunlight, and the Sun has an inclination in the sky. A walkable surface for maintenance access is also shown in FIG. 1.

This configuration has been determined as requiring too much surface area on the rooftop, and requiring reinforcement of the rooftop structure. This is therefore not convenient, and retrofitting for installing solar panels is hard and costly.

Furthermore, the solar panels are exposed to weather and other environmental conditions that require maintenance (dust accumulation, exposition to various debris, degradation of materials). These environmental conditions further require the photovoltaic cells of the solar panels to be protected by a coating because the raw (i.e., naked) photovoltaic cells cannot withstand these environmental conditions.

The coating over the raw photovoltaic cells has the undesirable effect of absorbing and reflecting a fraction of the incoming light, thereby reducing the overall performance of the coated solar panel compared to an uncoated one.

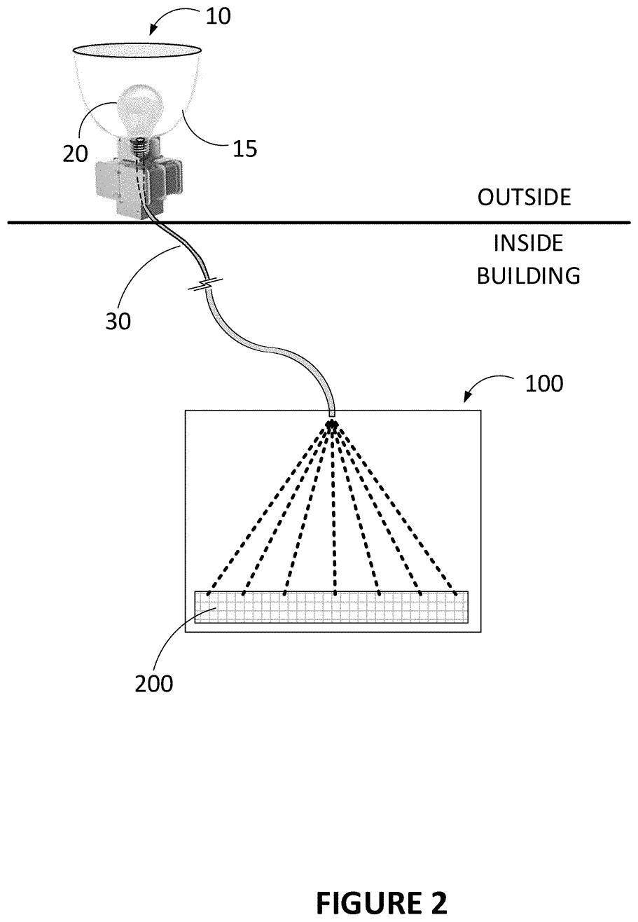

According to an embodiment, the solar panel 200 comprising photovoltaic cells is provided in a location where the weather and other damageable environmental conditions are substantially absent. According to an embodiment, the solar panel 200 is provided in an enclosure 100, as shown in FIG. 2, which acts as a protection against such potentially damaging environmental conditions. Protective walls can be used instead of an enclosure as long as they are advantageously positioned to protect the solar panel from dust, debris and the like. However, portability (for easy transport) is less likely to be ensured by protective walls than if an enclosure 100 is used. Indeed, the enclosure 100 is like a box. It can therefore be handled by someone and displaced where needed.

Protecting the solar panel by providing a protective enclosure 100 or any similar barrier makes possible the removal of the coating on the photovoltaic cells since the risk of damaging the raw photovoltaic cells is greatly reduced by providing the enclosure or walls. Therefore, according to an embodiment, the solar panel 200 is provided with raw photovoltaic cells, i.e., they have no antireflective coating, and possibly no protection coating. The performance of solar panel 200 is thereby increased, thereby mitigating the other losses that may result from guiding light from a collector to an enclosure, as described below.

In other words, the solar panel 200 has an exposed surface, the exposed surface consisting of (i.e., only made of) photovoltaic cells. In this embodiment, the solar panel 200 is free of any light-absorbing coating, or light-reflecting coating covering the photovoltaic cells, and also free of any protective coating, thus having raw photovoltaic cells (i.e., the silicon wafer) exposed, the photovoltaic cells having a wavelength range of conversion optimized for natural sunlight which is guided into the enclosure 100 using a light guide 30.

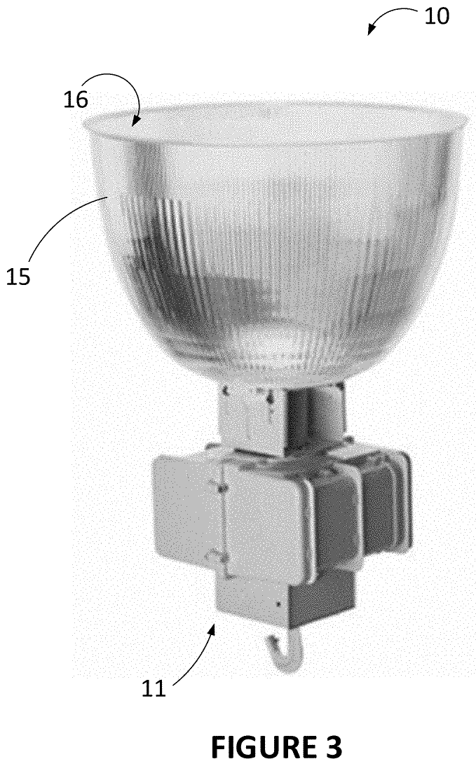

Providing such an enclosure 100 or walls blocks incoming sunlight, since the barrier for precipitation, dust, debris and the like also acts as a barrier for sunlight. Moreover, one of the advantages of installing a solar panel in an enclosure lies in the possibility of installing the enclosure at an arbitrary location, for example at a convenient location in a building. Therefore, there is a need for a light collector that would collect and redirect incoming sunlight toward the inside of the enclosure where it can be received by the solar panel. Referring to FIG. 3, there is shown an embodiment of a light collector 10.

According to an embodiment, the light collector 10 is designed to facilitate the retrofitting into existing buildings, i.e., the materials required to build the light collector 10 and its dimensions do not cause the light collector 10 to have excessive weight. The light collector 10 can be fabricated in small-weight versions that can be installed on rooftops without alterations to the roof structure to improve the weight-supporting capacity. The light collector 10 does not need to be inclined in order to have a satisfying performance.

Furthermore, as will be realized below, the functionality of redirecting light rather than concentrating it allows for a greater versatility in the user of the light collector 10. The light collector 10 can be used to transmit the light elsewhere in the building for lighting purposes, without any conversion, because light guides can be used to split the optical power into various guides that can then be routed to various locations for different applications.

FIG. 3 shows an exemplary light collector 10 that can be modular, like the enclosures 100. The light collector 10 of FIG. 3 comprises a concave portion 15. The concave portion 15 has a bowl shape and defines an inner surface 16 and an outer surface 17. The inner surface 16 needs to be reflective.

To provide a reflective inner surface 16, a reflective coating, made of an optically-reflective material, can be provided on the inner surface 16. Since the concave portion 15 is intended to substantially focus light, i.e., to bring light toward an approximate location, a substantially specular reflection is preferred over diffuse reflection. Preferably, the optically-reflective material should be selected to meet this requirement.

The term “optically-reflective” is intended to mean that relevant wavelength ranges are substantially reflected. Different wavelength ranges are expected to be reflected with different efficiencies (i.e., different percentages of reflection). The percentage that is not reflected is usually absorbed by the inner surface 16; this situation is usually undesirable, and therefore higher percentages of reflection are most often desired. In some circumstances, only certain/selected optical wavelengths are desired (wavelength ranges that are well converted by photovoltaic cells) while others are undesirable (e.g., infrared that only dissipate into heat, or other wavelength ranges that are not converted by photovoltaic cells and heat them, thereby decreasing their performance). These other undesirable wavelength ranges can be substantially cut off by providing a selective reflective coating. This configuration removes the undesirable (e.g., infrared) radiations from the radiations transmitted into the building, thereby preventing a major cause of heating in the building.

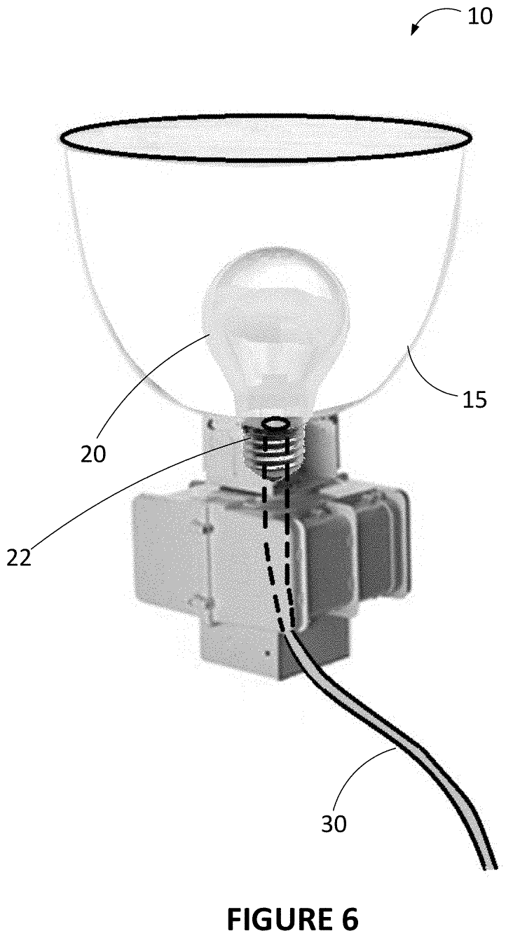

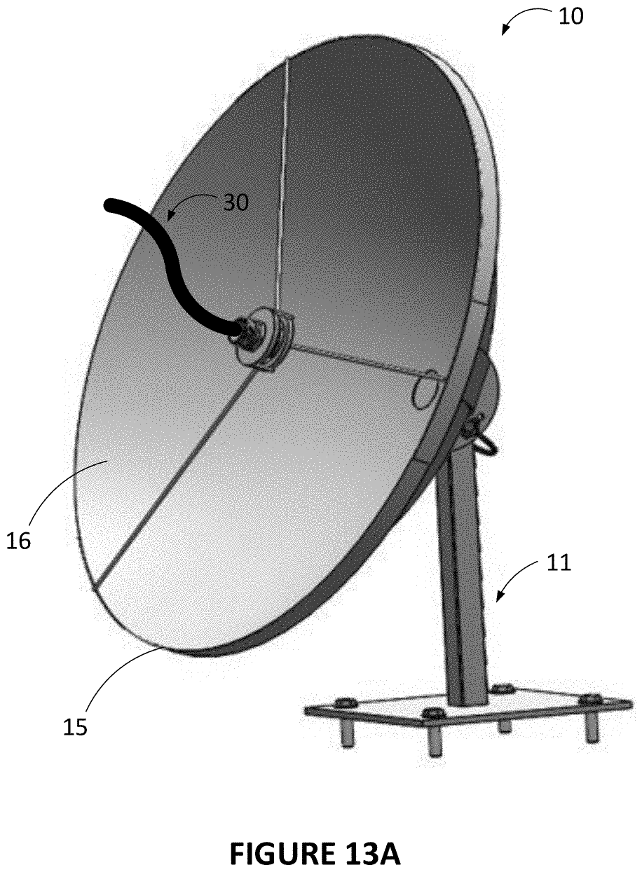

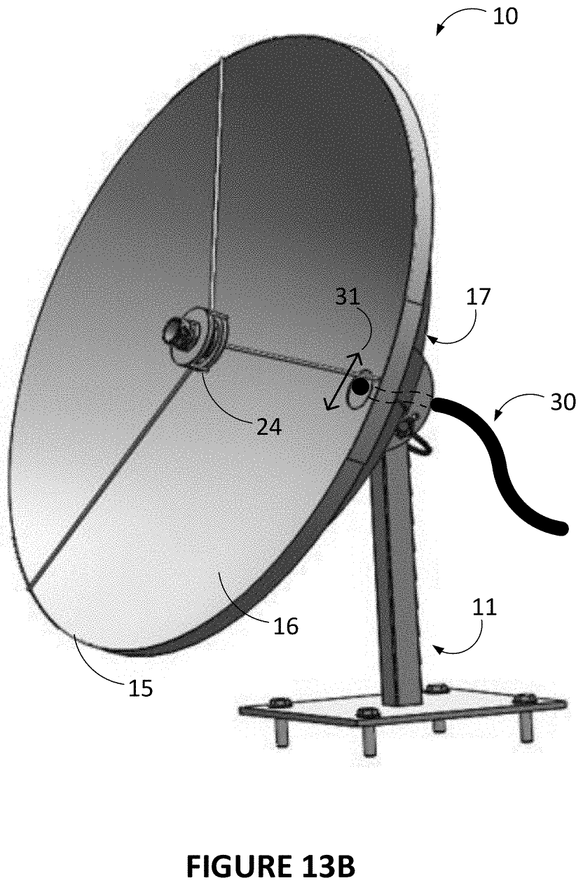

A light guide 30 (see FIGS. 6, 13A and 13B) is used for guiding the light collected by the light collector 10 toward the enclosure 100 containing the solar panel 200. The light guide 30 transmits light radiation on a certain distance, usually through a material (e.g., when the light guide 30 is an optical fiber). This material has optical properties including a coefficient of absorption, which is a function of the wavelength. Some wavelengths travel better than others (i.e., some wavelengths have higher percentages of transmission than others) in the light guide's material. The reflective properties of the inner surface 16 should therefore match the transmission properties of the light guide 30 to make sure that desirable wavelengths are both reflected in a suitably high percentage by the inner surface 16 and transmitted in a suitably high percentage by the light guide 30. If there are provided other optical parts (e.g., lenses, mirrors, couplers, multiplexers, etc.) with which light interacts, the same principle of consistency applies. If only specific wavelength ranges are transmitted with high efficiency, solar panels with photovoltaic cells that have greater efficiency with the wavelength ranges can be used.

As mentioned above, the concave portion 15 is used to substantially focus light toward a given point or spot. The concave portion 15 is concave because the concavity allows the focusing of incoming light. The concave portion 15 can have a paraboloid inner surface 16 (a paraboloid is the shape created by a rotating parabola), the optical properties of the paraboloid being known to those skilled in optical technologies. Most interestingly, light rays incoming in a line parallel with the axis of the paraboloid are focused to the focal point of the paraboloid. If light rays are not parallel to the axis, they end up being focused at other points which together define the focal plane of the paraboloid.

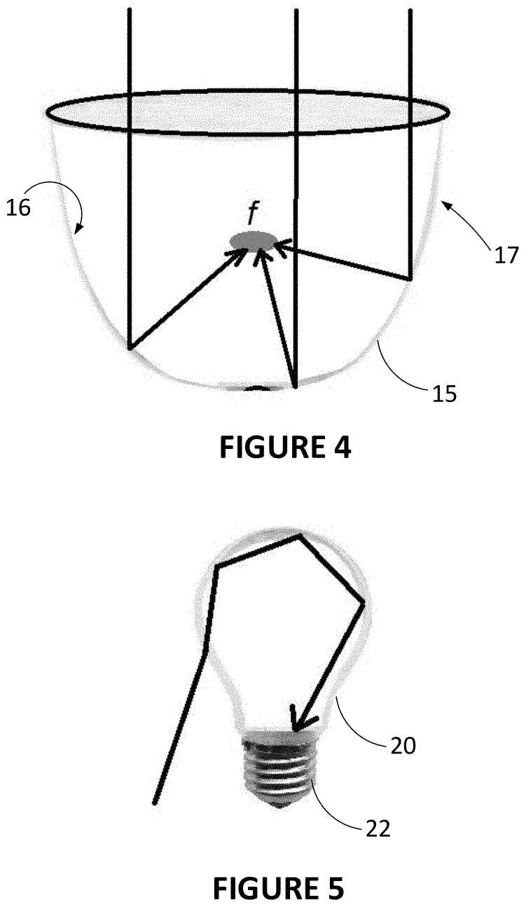

A light capturing element 20, illustrated in FIG. 5, is provided within the concavity of the concave portion (or slightly outside thereof), at or closed to the focal point, as shown in FIG. 6. The light capturing element 20 occupies some volume in space (i.e., it is not a mere point) and therefore it occupies some space around the focal point. That focal sport f is shown in FIG. 4. Preferably, the light capturing element 20 extends along some portion of the focal plane.

Since the light capturing element 20 occupies some space, the geometrical reflection properties of the concave portion 15 do not need to be perfect. For example, the shape of the inside of the concave portion 15 can differ from a paraboloid. For example, semi-spherical mirrors do not focus perfectly; the incoming light rays are focused toward a region herein named the focal spot f (also known in photography as a circle of confusion or blur spot, or in telecommunications as a focal cloud). If the concave portion 15 looks grossly like a paraboloid (even though there are irregularities, imperfections or other concave shapes), some sort of focal spot usually exists. The focal sport f is shown in FIG. 4. The location in space of this focal spot is identified and the light capturing element 20 is provided at this location. Alternatively, the concave portion 15 can be only grossly or vaguely in a paraboloid shape and still define a focal spot f that is more extended in space but still suitable from bringing light into the light capturing element 20.

The light capturing element 20 needs to comprise a light transmitting surface, such as glass, in order to effectively capture incoming and focused light. A substantial ball shape is a suitable shape that occupies space around the focal sport and that can capture light.

According to an embodiment, the light capturing element 20 is the envelope of a light bulb (i.e., the glass forming the bulb), as shown in FIGS. 5-6.

The light capturing element 20 needs a support 22 so it can stand and remain at the desired location (the focal sport), which is usually a floating point above the bottom of the concave portion 15. Strings or thin rods can be provided at an upper edge of the concave portion for holding the light capturing element 20 in suspension above the bottom of the concave portion 15, at the focal spot.

In a preferred embodiment, the support 22 is a lightbulb socket, as shown in FIGS. 5-6. It means that the light capturing element 20 is a lightbulb having both the glass bulb and its supporting socket. In comparison with a standard lightbulb, this embodiment has the filament removed.

In this embodiment, the support 22, which is a lightbulb socket, can be screwed, mounted (e.g., using a bayonet mount), pinned, or otherwise held in place at the bottom of the concave portion 15. A recess can be provided at the bottom of the concave portion 15 for mounting the support 22. The length of the support 22 and/or of the light capturing element 20 should be adjusted or selected so that the light capturing element 20 is high enough to be located at the focal spot.

As shown in FIG. 5, the light capturing element 20 has a shape adapted for capturing or retaining incoming light rays. Light rays refract while entering the glass or other material forming the light capturing element 20. They refract again inside the light capturing element 20 (which is shown as being hollow, either with a vacuum inside or air). If the index of refraction of the glass or other material forming the light capturing element 20 is in the right range, most of the light rays inside the light capturing element 20 undergo total internal reflection instead of transmission and refraction outside the light capturing element 20. If all interactions of the light rays inside the light capturing element 20 are total internal reflections, the light rays are captured inside the light capturing element 20. Some coatings, fillings and other materials with different indices of refraction can be added in the light capturing element 20 to ensure that the total internal reflections are occurring as needed. When a light ray reaches the bottom of the light capturing element 20, it can be collected by the light guide for transmission elsewhere. An example of a capture of a light ray is shown in FIG. 5.

By providing a light guide 30 such as an optical fiber that starts in the bottom of the light capturing element 20, captured light rays can enter the light guide 30 by one of its ends and travel therethrough to another location within the building where it is optically connected to the enclosure 100. A light guide 30 extending from the bottom of the light capturing element 20 and being routed out from the light collector 10 is shown in FIG. 6.

The resulting light collector 10 is therefore very compact. It does not weigh more than small objects being brought up temporarily on a rooftop and therefore, no structural solidifications are required to install the light collector 10 on a building's rooftop. Furthermore, the light collector 10, in an embodiment, can advantageously be built from existing objects that are widely available and rather inexpensive in comparison with usual components of sunlight harnessing technologies.

For example, there exist many types of lamps having a reflector with the same shape as the light collector 10 illustrated in FIG. 3. The reflectors also have a socket adapted for receiving a lightbulb. Therefore, the light collector 10 can be manufactured by providing a reflector of a lamp and a lightbulb. The lightbulb can be built without the filament and with an aperture provided at the bottom of its metallic socket. An optical fiber can be inserted into the bottom aperture of the lightbulb and secured therein (with adhesive or mechanical fixation means), while extending from the lightbulb for light transmission. The light collector 10 thus manufactured can be mounted on a support 11 for installation at a location where there is light, such as a rooftop. The light guide 30 is extending into the space under the roof (e.g., in the attic) and can be used for guiding elsewhere. A coupler (not shown) may be used to connect another light guide for further guiding.

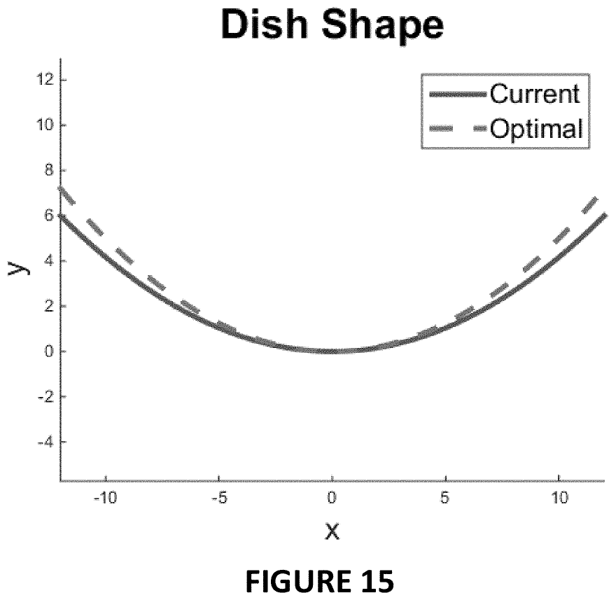

Now referring to FIGS. 13A-13B and FIG. 15, there is shown another embodiment of a light collector 10. The embodiment shown in these figures shares many features with the embodiment described above. However, it differs in that the concave portion is not a lamp, but rather a dish. The dish is a large surface which is the revolution surface of a parabola, i.e., a paraboloid. Dishes do not provide the advantage of being off-the-shelf products such as lamp sockets. Their cost is thus higher, but this additional cost results in increased performance which makes this trade-off a sensible choice.

FIG. 13A shows another exemplary embodiment of a light collector 10, where the inner surface 16 of the concave portion 15 is a dish installed on a support 11, where the light guide 30 has its light-receiving end at the focal spot of the light collector 10. In FIG. 13B, the center of the dish comprises a light-receiving end of the light guide 30, where a light collector can be provided as discussed above.

According to an embodiment, the dish has a diameter of 60 cm or 24 inches. The shape of the dish is preferably a paraboloid, i.e., a revolution surface of a parabola. The parabola may have a shape that depends on a variety of factors. For the contemplated purpose of collecting sunlight, a simulation may give an appropriate parabolic coefficient that gives high performance. For example, at a latitude of 45°, a simulation has shown that the parabola y=x²/20, where both parameters are in inches, would provide a particularly advantageous paraboloid with respect to performance in light collection. This may of course be different from this value, as shown in FIG. 15. For example, off-the-shelf dishes can be found where the parabola would rather be expressed as y=x²/24. Although suboptimal, this shape would still provide suitable performance.

According to an embodiment, the dish comprises a reflective coating applied onto the inner surface 16. Although advantageous for reflection purposes, the reflective coating may be hard to install or to maintain. According to another embodiment, the dish is rather chemically polished, mechanically polished and anodized (thereby resulting in a polished surface). This series of steps, when done properly, results in a high reflectivity of about 85%.

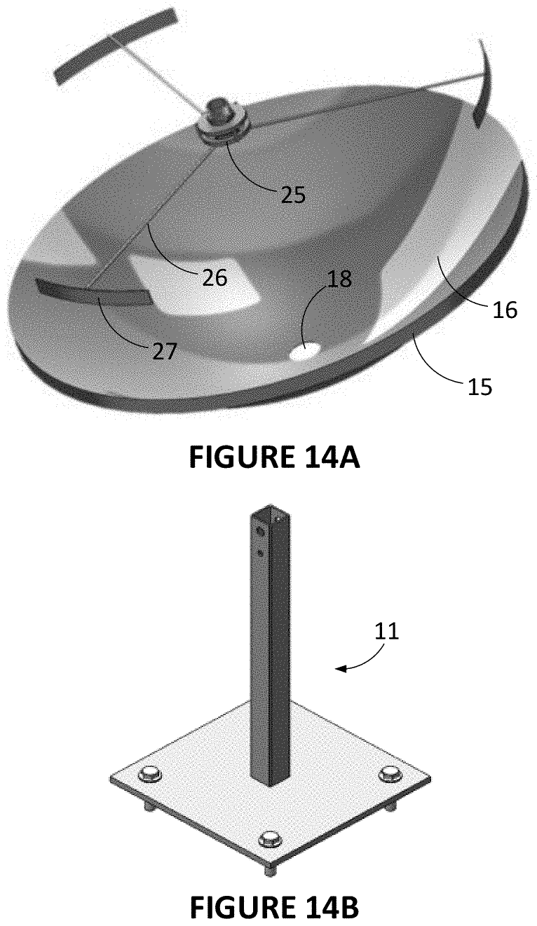

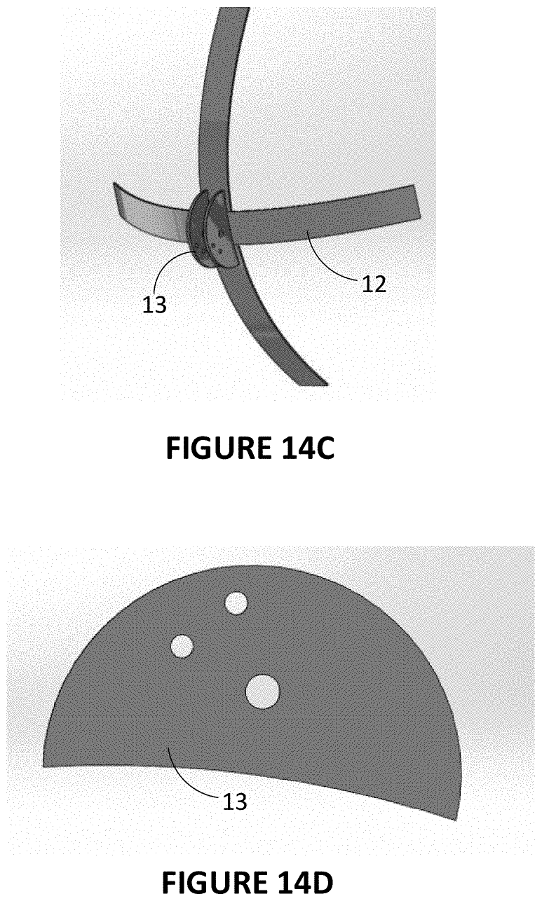

The dish can be heavy and thus needs an appropriate stand. The support 11 is shown in FIGS. 13A-13B and 14B. Advantageously, the support 11 is in steel or another material that is solid and that resists to rain and harsh weather.

According to an embodiment, the dish is supported on the support 11 by brackets, notably brackets 12 shown in FIG. 14C that fit with the outer surface 17 of the dish. Although soldering or fasteners can be contemplated as a means for fastening the dish to the brackets 12, the application of epoxy is preferable to avoid deformations that can happen over time or when there are temperature changes. The brackets 12 hold the dish and are themselves supported together by configuration brackets 13, shown in FIGS. 14C-14D, to which they can be fastened, glued or preferably welded for solidity. The configuration brackets 13 extend behind and away from the dish and, according to an exemplary embodiment, are adjustable in orientation. For example, they are shown as having a main hole by which a permanent pin can be inserted and serve as a hinge, and a pair of secondary holes where a removable pin can be removably and selectably inserted such that the hole in which the pin is inserted dictates the angular orientation of the brackets 12 and thus the dish. Therefore, the orientation of the dish can be easily adjusted, for example at season changes in which the pin is locked in a different position. The system required for such a change of orientation is easy to manufacture and does not incur substantial cost additions to the design.

According to an embodiment, the light guide 30 is an optical fiber. The optical fiber is preferably a multimode optical fiber having a large core in order to accept a substantially large range of incident angles of the incoming light rays onto the end surface of the optical fiber provided at the focal spot. An exemplary embodiment would comprise an optical fiber having a core diameter in the range of 10⁻² m, for example 12.4 mm, which would be expected to provide a large range of acceptance, i.e., a large range of angles of incoming light rays onto the exposed end of the light guide that would be effectively guided, such as 80°. Various types of optical may be acceptable, such as a step-index fiber. Cables made up of a bundle of optical fibers would also be a possible implementation for the light guide. The larger the light guide 30, the larger the light intensity of incident light that is effectively guided through the light guide 30, thereby improving performance. However, a large light guide is normally less flexible and thus harder to manipulate in the context of an easy-to-install and easy-to-maintain light collector. A light guide that would be too large would also affect the amount on the incoming sunlight, preventing it to reach the dish.

According an embodiment shown in FIG. 13B, there is provided a light-reflecting element 24 at the focal spot. This light-reflecting element 24 would be located at the focal spot and have a reflecting surface oriented toward the concave portion 15. In that case, the center of the dish would be pierced, e.g., the hole 18 at the exit at the center of the concave portion 15, to provide the light-receiving end of the light guide 30, as described above in reference with the embodiment described previously.

This embodiment is advantageous in that the light guide 30 does not obstruct incoming sunlight. However, the light-reflecting element 24 at the focal spot may not redirect correctly the light reflected thereon toward the light-receiving end of the light guide 30, since the real-life focal spot is not a point. Since the focal point is in fact a focal spot, the light-reflecting element 24 may reflect light into a second focal spot that is expected to be at the light-receiving end of the light guide 30, but that is in fact and even more diffuse focal spot. If this problem arises because of the dish shape, it would be preferable to avoid the light-reflecting element 24.

There can thus be provided another embodiment as shown in FIGS. 13A and 14A. There is provided a light guide holder 25 at the focal spot. The light guide holder 25 can have an annular shape or any other shape suitable to hold the light guide 30. Light reflected by the inner surface 16 thus enters the light guide 30 directly, without any other secondary optics. This helps avoiding the problem of a focal spot becoming more diffuse at each reflection. The light guide holder 25 needs to be maintained at the focal spot. The holder arms 26 can be used for this purpose. The holder arms 26 are held by pads 27 that can urge onto the dish from the inside or more preferably hold the outside edge of the dish.

This embodiment has the light guide 30 partly obstruct the incoming sunlight. However, direct light entry into the light guide 30 at the first focal spot is advantageous for light collection efficiency.

It should be noted that the use of a light-reflecting element 24 at the focal spot or a light guide holder 25 would also apply to the embodiment described above and not only to a dish. The use of arms 26 and pads 27 can also apply to the light-reflecting element 24.

The embodiment of the light collector 10 shown in FIGS. 13A-13B also illustrates that, optionally, a lens or lens arrangement 31 is provided in front of the light-receiving end of the light guide 30. The lens arrangement 31 therefore focuses the light reflected either from the concave portion 15 or the light-reflecting element 24 toward the light-receiving end of the light guide 30.

The light collector 10 thus manufactured, according to any of the embodiments presented above, can be mounted on a support 11 for installation at a location where there is light, such as a rooftop. The light guide 30 extends into the space under the roof (e.g., in the attic) and can be used for guiding light elsewhere. A coupler (not shown) may be used to connect another light guide for further guiding.

Therefore, the light collector 10 has a geometry which should define a focal spot, as shown in FIG. 4, and the focal spot is the location where the light capturing element 20 should be located. A parabolic light collector would define a focal point in space; having an imperfect parabola as the shape of the concave portion of the light collector provides a focal spot. In other words, the concave portion is for receiving incoming light and comprises a reflective inner surface for directing at least partly the incoming light toward a focal spot defined by a geometry of the concave portion. The light capturing element 20 should therefore be held by a support at that location. For example, by using the lightbulb-shaped light capturing element 20 of FIG. 5 at the focal spot of FIG. 4, one may arrive at the result shown in FIG. 6. Alternatively, in FIG. 13, a light-receiving end of a light guide 30 is located at the focal spot of a dish. The light capturing element 20 is located at the focal spot and substantially captures the incoming light directed toward the focal spot and to reflect the incoming light within the light capturing element toward an exit thereof, normally an optical connection to an input end of a light guide 30.

As mentioned above, the light capturing element 20 may advantageously have a lightbulb shape, as shown in FIGS. 5-6. However, contrarily to the configuration of FIG. 13, in FIG. 6, the light reflected by the light collector 10 is not incoming in the proper direction and the light capturing element 20 needs to be able to change the direction of the received light such that it can be guided elsewhere. According to an embodiment, the light capturing element 20 is has an outside material (defining the lightbulb shape) which is transparent, wherein a refraction index of the light capturing element 20 is in a range ensuring substantial total inner reflection in order to reflect the incoming light within the light capturing element toward the exit. Thanks to that reflection, as shown in FIG. 5, the support 22 may eventually receive light, and a light guide 30 may be connected there as shown in FIG. 6.

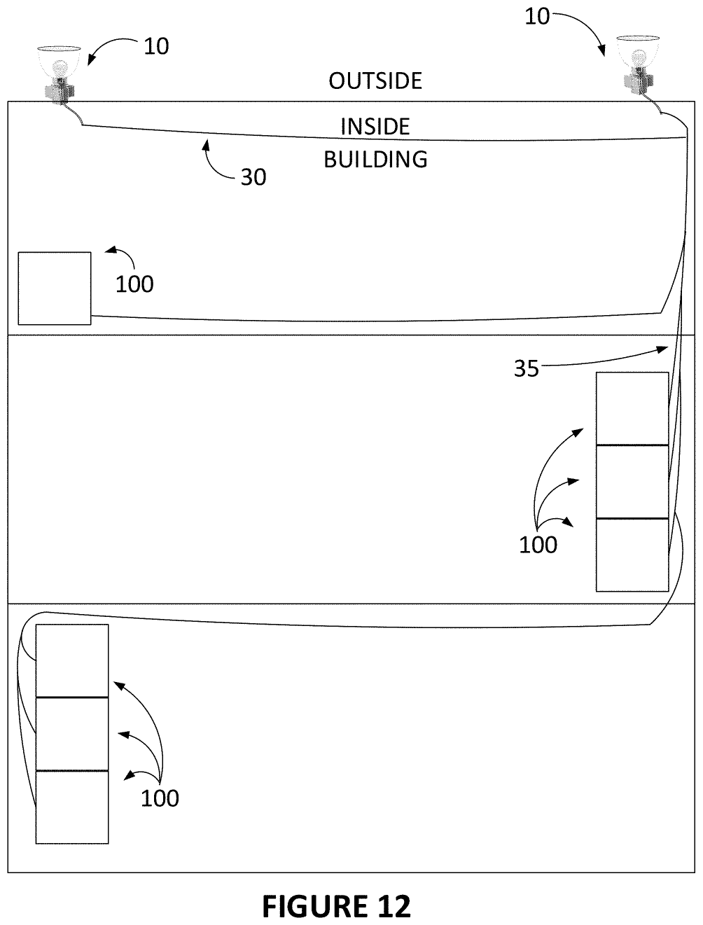

The guided light can be used for conversion to electricity by a photovoltaic cell of the solar panel 200, or for lighting (general lighting, task lighting, etc.), heating, etc. The lighting, heating and conversion to electricity can be performed anywhere permitted by the length of the light guide, usually inside the building, as shown in FIG. 12.

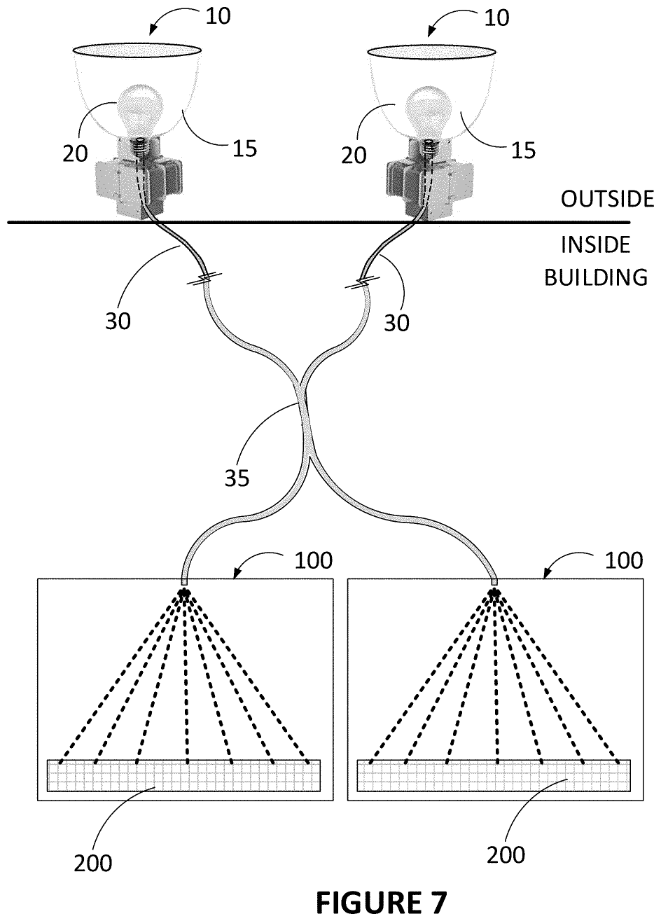

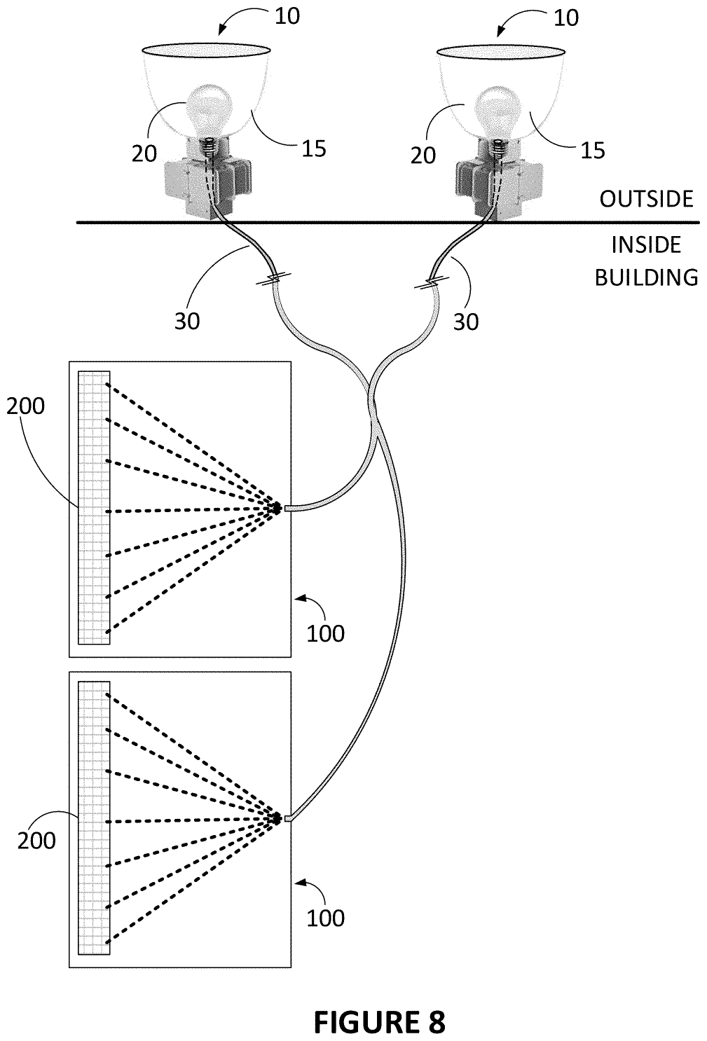

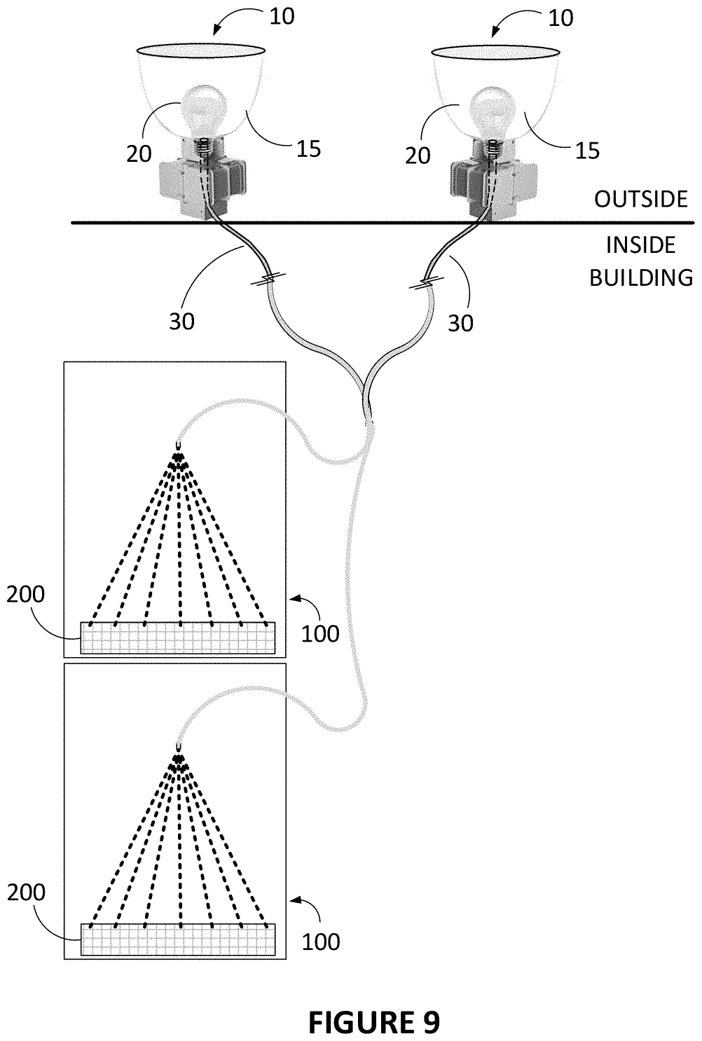

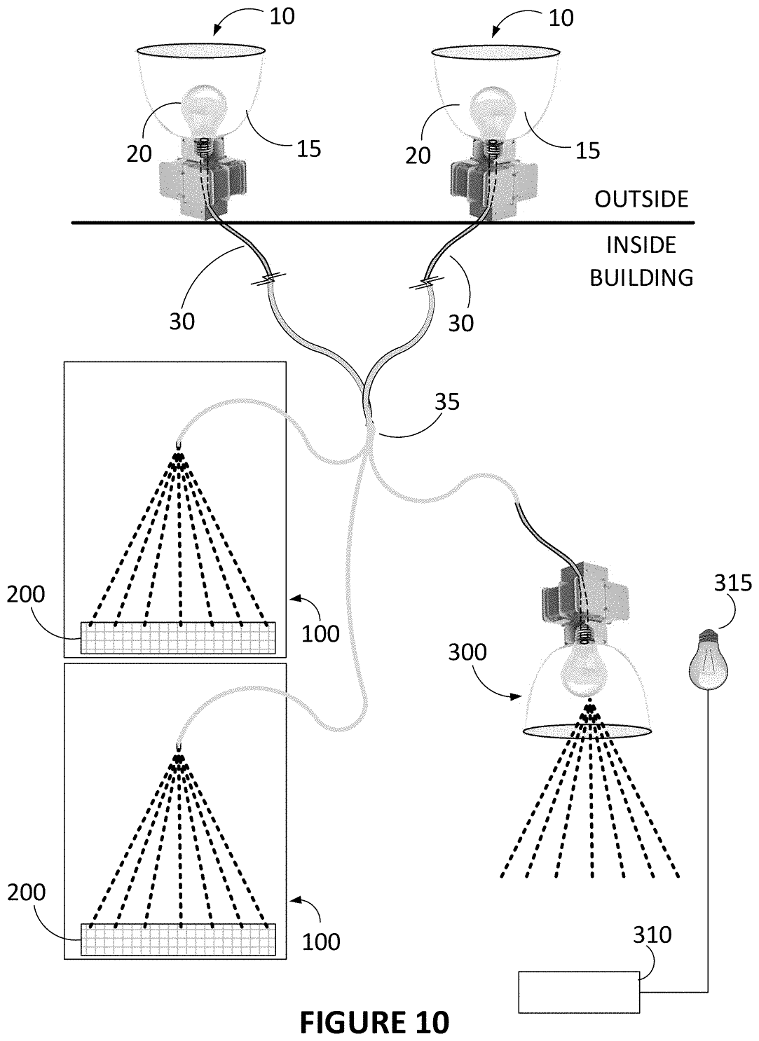

FIGS. 7-10 show that an arbitrary number of light collectors 10 can be used with an arbitrary number of applications, for example, an arbitrary number of enclosed solar panels 200. They can also be installed side-by-side (FIG. 7), piled up (FIGS. 8-10), and/or scattered over an area, e.g., on different floors of a building (FIG. 12). This arbitrary number of light collectors 10 is permitted by the modular nature of the light collectors, and the arbitrary number of enclosed solar panels 200 is permitted by the modular nature thereof. The light guides 30 and/or the bundle 35 of a plurality of light guides 30 ensure the optical connection between the light collectors 10, on one side, and the enclosed solar panels 200 on the other side. Applications different from solar panels 200 can also be provided at the application end of the system, for example lighting 300, as shown in FIG. 10 where the applications optically connected to the light collectors 10 via light guides 30 are heterogeneous.

If a plurality of light collectors 10 and a plurality of applications such as enclosed solar panels 200 are used, they can be either connected directed directly from one to another, as shown in FIG. 2, or can be connected via a bundle 35 of light guides 30. The bundle 35 may comprise light guides 30 fastened together to form a bundle, or merged together to form one larger light guide than can be split at a downstream location into a plurality of light guides for delivering light into applications.

As shown in FIGS. 7, 8, 9, 10 and 12, the plurality of light collectors 10 (i.e., at least two, or even more than two) can advantageously form a network of light collectors 10, where they are connected together by having their light guides 30 connected together, i.e., the different light guides 30, each originating from a different one of the plurality of light collectors 10, are coupled and merge together (or at least some of them merge together by optical coupling, or are mechanically bundled together into a harness). The light carried by the light guides 30 can be redirected to one enclosed solar panel 200, with high intensity (combining all sources), or to a plurality of enclosed solar panels 200 (therefore, connected to at least one unit), which does not necessarily correspond to the plurality of light collectors 10, i.e., their number can be different. In this case, the light guides 30 may split after being merged and/or bundled.

As shown in FIG. 10, there may be a hybrid output for the network, such that at least a portion of the collected light is distributed to a lighting 300 to which the light guide 30 is connected at a corresponding one of its output ends. According to this embodiment, the system comprising the network may further comprise light sensors 310 which monitor the lighting output of such lighting 300 in the room. Depending on the intensity from the lighting 300, which depends on the light collected by the system, the light sensor 310 in the room (which can be a photocell) will instruct the electrical lighting 315 of the building to complement the lighting 300 such that the total overall lighting (collected natural light plus electrical lighting) reaches a desired level of lighting for the room.

This configuration ensures that the whole system can be modular at both levels: collection and conversion. As shown in FIG. 12, the light collectors 10 and the solar panels in their enclosures 100 are both disseminated respectively on and in the building according to the available space. Any convenient configuration of light collectors 10 and the solar panels in their enclosures 100 can be contemplated. The enclosures 100 containing the solar panels 200 are shown inside a building but can be elsewhere since the enclosures form a self-contained unit that can be displaced and still be used as long as it is optically connected to the light guides 30 which bring light in.

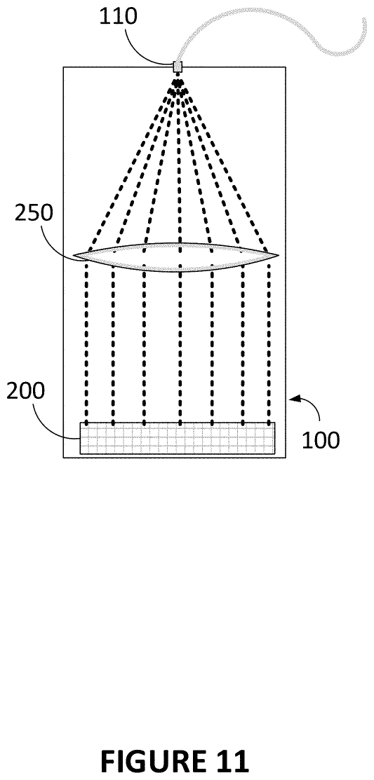

An optical connector 110 can be provided at the entrance of the enclosure 100, as shown in FIG. 11. This optical connector 110 can be mechanically coupled to the light guide 30 or bundle 35 for receiving light in the enclosure 100. For example, the optical connector 110 may comprise a snap-fit fastener cooperating with a similar piece on the end of the light guide 30, for clipping the light guide 30 into optical connector 110. In another example, it could rather comprise a screwable collet that shrinks inwardly when screwed to hold the light guide 30 in place.

FIGS. 2-10 show that the light exiting the light guide 30 into the enclosure 100 is simply emitted toward the solar panel 200. However, there may be cases when it is desirable to provide a specific light intensity profile over the area of the solar panel 200. For example, a lens system 250, which can go from very simple to very complex, can be provided inside the enclosure 100 to give a specific intensity profile to the incoming light on the solar panel 200. According to an embodiment, the lens system 250 is a convergent lens acting as a collimator to collimate the diverging light beam into a parallel light beam that is received by the solar panel in a more uniform intensity over the area of the solar panel 200.

Advantageously, the lens system 250 or collimator comprises an adjustable lens arrangement which focuses more or less to reach a predetermined, optimizes uniform light intensity on the solar panel. Indeed, there is usually a bell curve of efficiency based on the light intensity sent to the solar panel. An optimal (maximum) efficiency can be reached by diffusing or concentrating the light by adjusting the focus of the lens system 250 that collimates the light incoming onto the unit. The electrical output of the solar panel 200 may be used to assess the efficiency to drive the dynamical adjustment of the lens system 250.

Since the solar panel 200 is enclosed within the enclosure 100, it can be oriented arbitrarily inside the enclosure 100. If it is not provided horizontally on the bottom of the enclosure, it needs to be held firmly in place to avoid falling down using a fastener such as clips, screws, a mounting frame, adhesive or any other suitable means for fastening the solar panel 200 to the enclosure 100.

According to an embodiment, there is no reflection taking place in the enclosure 100 for the incoming light. Once the light enters the enclosure, it is either untouched or collimated by a lens, and reaches the solar panel 200 without any reflector on its path from the output of the light guide 30 to the absorption and conversion on the solar panel 200. The input in the enclosure 100 therefore needs to be directed toward the location of the solar panel 200 such that the output end of the light guide 30 points toward the location of the solar panel 200 directly, not requiring any reflector inside the unit on the light path.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A system comprising a unit for light conversion in a building, the unit comprising:
a solar panel comprising photovoltaic cells, the solar panel being free of any light-absorbing coating or light-reflecting coating covering the photovoltaic cells, thus having raw photovoltaic cells exposed, the photovoltaic cells having a wavelength range of conversion optimized for natural sunlight;
an enclosure surrounding the solar panel and preventing an exposure of the solar panel from direct light from outside the enclosure, the enclosure comprising an input; and
the system further comprising:
a light collector located outside the building for collecting natural sunlight and substantially guiding the natural sunlight into the light guide, the light collector comprising:
a concave portion for receiving incoming light and comprising a reflective inner surface in the concave portion facing the incoming light for reflecting the incoming light toward a focal spot defined by a geometry of the concave portion;
a light capturing element, located at the focal spot, and having a lightbulb shape to substantially capture the incoming light directed toward the focal spot and to reflect the incoming light within the light capturing element toward an exit thereof; and
a light guide comprising an end provided at the exit of the light capturing element for guiding captured light outside of the light collecting, the light guide having two ends and comprising an optical fiber adapted for optical connection, one of the two ends provided at the exit of the light capturing element, another one of the two ends, namely an output end, connectable to the enclosure via the input, the light guide having the output end located by the input of the enclosure and directed directly toward a surface of the photovoltaic cells for illumination thereof.

2. The system of claim 1, wherein the light capturing element is transparent, wherein a refraction index of the light capturing element is in a range ensuring substantial total inner reflection in order to reflect the incoming light within the light capturing element toward the exit of the light capturing element.

3. A unit for light conversion receiving light from a light collector, the unit comprising:
a solar panel comprising photovoltaic cells, the solar panel being free of any light-absorbing coating, or light-reflecting coating such as to be raw;
an enclosure surrounding the solar panel and preventing an exposure of the solar panel from direct light from outside the enclosure, the enclosure comprising an input opposing the solar panel, wherein the unit is free of any reflector such that the input points directly toward the solar panel to which it is opposed; and
a light collecting device comprising:
a concave portion for receiving incoming light and comprising a reflective inner surface in the concave portion facing the incoming light for reflecting the incoming light toward a focal spot defined by a geometry of the concave portion; and
a light guide having a light-receiving end held at the focal spot and toward the concave portion to substantially capture the incoming light directed toward the focal spot, the light guide extending from the light-receiving end held at the focal spot in the light collector located outside the enclosure to the enclosure, the light guide being connectable to the enclosure via the input.

4. The unit for light conversion of claim 3, further comprising a collimator installed between the solar panel and the input for the light guide for a more uniform light intensity on the solar panel.

5. The unit for light conversion of claim 3, wherein the collimator comprises an adjustable lens arrangement which focuses more or less to reach a predetermined, optimizes uniform light intensity on the solar panel.

6. A system for a building for performing light conversion in a building, the system comprising:
at least one unit located inside the building and comprising:
a solar panel comprising photovoltaic cells, the solar panel being free of any light-absorbing coating, or light-reflecting coating covering the photovoltaic cells, thus having raw photovoltaic cells exposed; and
an enclosure surrounding the solar panel and comprising an input; and
at least one light collector located outside the building, the at least one light collector comprising:
a concave portion for receiving incoming light and comprising a reflective inner surface in the concave portion facing the incoming light for reflecting the incoming light toward a focal spot defined by a geometry of the concave portion; and
a light guide forming a network and extending from the at least two light collectors to the at least one unit, the light guide having a light-receiving end held at the focal spot and toward the concave portion to substantially capture the incoming light directed toward the focal spot, the light guide being connectable to the enclosure of the at least one unit via the input.

7. The system for light conversion of claim 6, wherein the input for the light guide is installed at the focal spot to provide optical connection to the light collector.

8. The system for light conversion of claim 6, wherein the at least two unit comprises more than two units in the building, the light guide forming the network extending from the at least one light collector to the at least one unit.

9. The system for light conversion of claim 6, wherein each of the at least one light collector comprises a concave portion directly exposed to the outside.

10. The system for light conversion of claim 6, further comprising at least one lighting output to which the light guide is connectable to output light therefrom.

11. The system for light conversion of claim 10, further comprising a light sensor to monitor the light outputted from the lighting output, the light sensor instructing a level of electrical lighting in the room of the light output.
